(19) United States
(12) Patent Application Publication
(10) Pub. No.: US 2018/0270076 A1
(43) Pub. Date: Sep. 20, 2018

(54) SMART NETWORKING OF TRADITIONAL APPLIANCES

(71) Applicant: QUALCOMM Incorporated, San Diego, CA (US)

(72) Inventors: Sreekanth Natarajan, Chennai (IN); Arun Alagarsamy, Chennai (IN); Muthuchamy Kumar, Chennai (IN); Seshadri Ramakrishnan Sankarapuram, Chennai (IN); Subramanian Anantharaman, Chennai (IN); Ravishankar Subramanian, Chennai (IN); Swathi Kamalakannan, Chennai (IN); Sanjib Kumar Mohapatra, Chennai (IN)

(21) Appl. No.: 15/908,744

(22) Filed: Feb. 28, 2018

(30) Foreign Application Priority Data
Mar. 17, 2017 (IN) 201741009241

(51) Int. Cl. H04L 12/28; H04L 12/66

(52) U.S. Cl. CPC H04L 12/2807; H04W 84/12; H04L 12/2816; H04L 12/66

(57) ABSTRACT

This disclosure provides systems, methods and apparatus, including computer programs encoded on computer storage media, for an appliance interface apparatus. In some implementations, the appliance interface apparatus enables network-based control of a traditional appliance. The appliance interface apparatus includes an appliance socket to connect the traditional appliance to a power source. The appliance interface apparatus includes a first network interface for establishing a first communication link with a smart appliance controller in a network. The appliance interface apparatus can establish a second communication link with a control circuit for controlling the traditional appliance. Upon receiving a command from the smart appliance controller, the appliance interface apparatus sends a signal via the second communication link to the control circuit to control an operation of the traditional appliance in accordance with the command.

### CROSS-REFERENCE TO RELATED APPLICATIONS

This Patent Application claims priority to India Provisional Patent Application No. 201741009241 filed Mar. 17, 2017 entitled “SMART NETWORKING OF TRADITIONAL APPLIANCES,” and assigned to the assignee hereof. The disclosure of the prior Application is considered part of and is incorporated by reference in this Patent Application.

### Technical Field

This disclosure generally relates to the field of communication, and more particularly to connecting appliances in a communication network.

### Description of the Related Technology

Developers have promoted the concepts of “smart” appliances which allow users to control or automate some operations of commonly-used appliances via a network. For example, consumers who desire home automation may purchase products such as smart light bulbs or other types of smart appliances (also marketed as network-connected appliances). However, an appliance may be in a location that prevents it from easily being added to the network. For example, the appliance may be placed in a location that causes it to have a weak wireless signal to a wireless network or the appliance may be in a location that does not have wireless coverage at all. It may be inconvenient for a consumer to move the appliance or enhance the wireless coverage for a wireless network. While some new smart appliances may have multiple network interfaces, such appliances may still be relatively expensive or unavailable in some markets. Furthermore, there are inherent disadvantages associated with replacement of existing appliances with newer appliances. Such disadvantages include the waste disposal of discarded appliances, byproducts of manufacturing replacement appliances, and costs to consumers for replacement of multiple appliances in a physical location. Additionally, deployment of smart technology within an environment may be cost prohibitive, difficult for consumers, or unavailable in some markets.

### SUMMARY

The systems, methods, and devices of this disclosure each have several innovative aspects, no single one of which is solely responsible for the desirable attributes disclosed herein.

One innovative aspect of the subject matter described in this disclosure can be implemented in an appliance interface apparatus for networking a traditional appliance. The appliance interface apparatus may connect the traditional appliance to a power source via an appliance socket of the appliance interface apparatus. The appliance interface apparatus may establish, via a first network interface of the appliance interface apparatus, a first communication link with a smart appliance controller in a network. The appliance interface apparatus may establish a second communication link with a control circuit for controlling the traditional appliance. The appliance interface apparatus may receive, via the first communication link, a command from the smart appliance controller. The appliance interface apparatus may send a signal via the second communication link to the control circuit. The signal may control an operation of a traditional appliance in accordance with the command.

In some implementations, the appliance interface apparatus may include a processor for receiving the command. The processor may be powered by the power source.

In some implementations, sending the signal for controlling the operation of the traditional appliance may include translating the command from a first command protocol of the network to the signal for use on the second communication link.

In some implementations, the control circuit may be integrated into the traditional appliance.

In some implementations, the control circuit may include a power supply relay between a power source and the traditional appliance. The signal may cause the control circuit to enable or disable power to the traditional appliance via the power supply relay.

In some implementations, sending the signal for controlling the operation of the traditional appliance may include sending the signal to the control circuit via an isolator circuit between the appliance interface adapter and a power supply relay of the control circuit.

In some implementations, the control circuit may include a dimmer circuitry between a power source and the traditional appliance. The signal may control dimming of the traditional appliance via the dimmer circuitry.

In some implementations, the traditional appliance is a traditional light bulb, the appliance interface apparatus is a light bulb holder for holding the traditional light bulb, and the appliance socket is a lightbulb socket. In some implementations, the processor, the power supply relay, and the light bulb socket are physically integrated into the light bulb holder.

In some implementations, the appliance interface apparatus may include more than one network interface.

In some implementations, the appliance interface apparatus may be capable of receiving the command from the smart appliance controller via more than one network communication medium.

In some implementations, establishing the second communication link may include establishing the second communication link via a second network interface of the appliance interface apparatus.

In some implementations, the first network interface may be a powerline communication (PLC) and the second network interface may be a wireless local area network (WLAN) interface.

In some implementations, the appliance interface apparatus may be capable of bridging communication between a PLC network and a WLAN.

Another innovative aspect of the subject matter described in this disclosure can be implemented in an appliance interface apparatus that includes a processor, an appliance socket for connecting a traditional appliance to a power source, at least a first network interface, and memory having instructions stored therein. The instructions, when executed by the processor may cause the appliance interface apparatus to establish, via the first network interface, a first communication link with a smart appliance controller in a network. The instructions, when executed by the processor may cause the appliance interface apparatus to establish a second communication link with a control circuit for controlling the traditional appliance. The instructions, when executed by the processor may cause the appliance interface apparatus to receive, via the first communication link, a command from the smart appliance controller, and send a signal via the second communication link to the control circuit. The signal may control an operation of the traditional appliance in accordance with the command.

In some implementations, the processor may be powered by the power source.

In some implementations, the instructions to send the signal for controlling the operation of the traditional appliance may include instructions which, when executed by the processor, cause the appliance interface apparatus to translate the command from a first command protocol of the network to the signal for use on the second communication link.

In some implementations, the instructions to receive the command may include instructions which, when executed by the processor, cause the appliance interface apparatus to receive the command from the smart appliance controller via one of multiple network interfaces capable of receiving the command.

In some implementations, the appliance interface apparatus may include a second network interface for establishing the second communication link to the traditional appliance.

In some implementations, the first network interface is a PLC interface and the second network interface is a WLAN interface.

Another innovative aspect of the subject matter described in this disclosure can be implemented in a computer-readable medium having instructions stored therein. The instructions, when executed by the processor may cause the appliance interface apparatus to establish, via the first network interface, a first communication link with a smart appliance controller in a network. The instructions, when executed by the processor may cause the appliance interface apparatus to establish a second communication link with a control circuit for controlling the traditional appliance. The instructions, when executed by the processor may cause the appliance interface apparatus to receive, via the first communication link, a command from the smart appliance controller. The instructions, when executed by the processor may cause the appliance interface apparatus to send a signal via the second communication link to the control circuit. The signal may control an operation of the traditional appliance in accordance with the command.

Another innovative aspect of the subject matter described in this disclosure can be implemented in a system in an appliance interface apparatus. The system may include means for connecting a traditional appliance to a power source via an appliance socket of the appliance interface apparatus. The system may include means for establishing, via a first network interface of the appliance interface apparatus, a first communication link with a smart appliance controller in a network. The system may include means for establishing a second communication link with a control circuit for controlling the traditional appliance. The system may include means for receiving, via the first communication link, a command from the smart appliance controller. The system may include means for sending a signal via the second communication link to the control circuit, the signal for controlling an operation of the traditional appliance in accordance with the command.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a system diagram of example traditional appliances and smart control.

FIG. 2 shows a system diagram of an example appliance interface apparatus for networking a traditional appliance via a wireless local area network (WLAN).

FIG. 3 shows a system diagram of an example appliance interface apparatus for networking a traditional appliance via a WLAN or a powerline communication (PLC) network.

FIG. 4 shows a block diagram of an example appliance interface apparatus.

FIG. 5 shows a message flow diagram of an example traditional appliance using an appliance interface apparatus.

FIG. 6 shows a system diagram of example appliance interface apparatuses for controlling traditional appliances.

FIG. 7 shows a system diagram of example appliance interface apparatuses capable of bridging powerline networking and wireless networking while controlling traditional appliances.

FIG. 8 shows a flowchart of an example appliance interface apparatus.

FIG. 9 shows a block diagram of an example electronic device for implementing aspects of this disclosure.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

A “smart” appliance is any appliance which can be controlled, automated, or managed using a network-based command protocol. Some manufacturers may market smart appliances as network-connected appliances, Internet-of-Things (or “IOT”) devices, smart home devices, and the like. A traditional appliance (such as a coffee machine, refrigerator, lamp, washing machine, dishwasher, toaster, or the like) is any appliance that was not traditionally intended to operate on a network. Unless the traditional appliance can be added to the network, the traditional appliance cannot by controlled, automated, or managed by a network-based command protocol. In some implementations, a traditional appliance may be equipped with a control circuit which could be controlled by a signal. However, the traditional appliance may not have network interface for communicating via a network or may be in a location where wireless network communication is unstable, unavailable, or unreliable. For example, the wireless network communication may be degraded as a result of very poor signal strength. Network-enablement of traditional appliances may enable smart control over the traditional appliance. In this disclosure, implementations will be described in the smart home automation environment. However, some other implementations may be used in commercial locations, manufacturing locations, or any environment in which smart appliances might be useful. It may be costly for a consumer to replace traditional appliances with newer or upgraded smart appliances. Providing a network interface with common command protocol may enable a user to enjoy smart control features on a traditional appliance while reducing cost and complexity.

In this disclosure, an appliance interface apparatus enables network-based control over a traditional appliance. The appliance interface apparatus can establish a first communication link with a smart appliance controller in a network. The appliance interface apparatus can establish a second communication link with a control circuit of the traditional appliance. The appliance interface apparatus can receive a command (such as a home automation command) from the smart appliance controller and send a signal to the control circuit tocontrol an operation of the traditional appliance in accordance with the command. Using the techniques in this disclosure, a traditional appliance (such as a traditional light bulb) can be controlled by a smart appliance controller.

In some implementations, an appliance interface apparatus may establish the the first communication link using a wireless wide area network connection. For example, some telecommunications companies are deploying wireless broadband technology (such as fifth-generation, or 5G, wireless communication technology) to provide wireless broadband connectivity to the Internet. An appliance interface apparatus that connects to the Internet using a wireless broadband connection may serve as a gateway for other appliance interface apparatuses in a location. For example, a group of appliance interface apparatuses may communicate with each other using a powerline communication mesh topology, while one or more of the appliance interface apparatuses also may have a wireless broadband connection. Such a configuration can enable control of appliances in a location via a remote Internet connection even if the user is not near the local network where those appliances are located. Furthermore, a group of appliance interface apparatus may form a mesh network with multiple network connections for increased resiliency and coverage within an environment.

In some implementations, an appliance interface apparatus may enable control of disparate appliances. For example, an appliance interface apparatus may implement a command translation utility to translate a command (such as a home automation command) from the smart appliance controller into a signal that is specific to the type of appliance that it supports. In some implementations, the command translation utility may be referred to as a hardware abstraction layer and may downloaded as a “hosted application” on the appliance interface apparatus. Using a hosted application may be useful when replacing an appliance because a different command translation utility can be used for the new device while maintaining the same smart appliance controller.

Particular implementations of the subject matter described in this disclosure can be implemented to realize one or more of the following potential advantages. For example, consumers could use traditional applianceswith features associated with smart appliances. In some implementations, consumers may continue to utilize a less expensive or existing traditional appliance while controlling the traditional appliance as if it was a smart appliance. For example, a consumer could install an appliance interface apparatus to enable a common network-based command protocol via a control circuit associated with a traditional appliance. Connectivity may be improved through the use of mesh networking and wireless broadband connectivity. Control of traditional appliances also may be enhanced due to the command translation capabilities of an appliance interface apparatus.

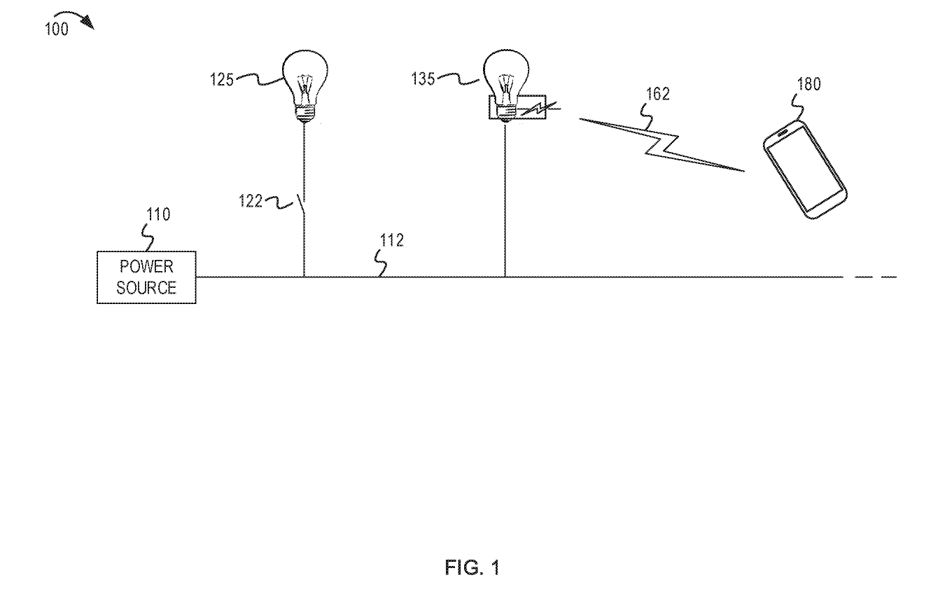

FIG. 1 shows a system diagram of example traditional appliances and smart control. The system 100 includes a power source 110 which provides power via a powerline medium 112. For example, the powerline medium 112 may include home electrical power wiring. A first appliance 125 (such as a traditional light bulb) may be coupled to the powerline medium 112 via a switch 122. For example, the switch 122 may be a wall switch, dial or dimmer, which requires manual operation to turn on or turn off the light. Neither the first appliance 125 nor the switch 122 are capable of being controlled by a network-based command protocol because they both lack a network interface in FIG. 1.

The system 100 also shows a second appliance 135 which receives power from the powerline medium 112. The second appliance 135 (such as a “smart light bulb”) may be capable of receiving a command from a client device 180 because it may have a wireless network interface. For example, the client device 180 may send a command via a wireless link 162 (such as Wi-Fi or Bluetooth®) to the second appliance 135. The second appliance 135 may have communication capability built into the second appliance 135. To take advantage of the smart home automation, a consumer might replace an existing traditional appliance (such as the first appliance 125) with a new appliance (such as the second appliance 135). However, a cost-conscientious homeowner may not want to replace traditional appliances with new appliances. Furthermore, there may be many different types of traditional appliances (such as various brands or types of equipment) within a home or commercial environment. The ability to quickly network traditional appliances and use a standard command protocol within the home or commercial environment may increase the rate of adoption for smart controller technology and improve compatibility or consistency for controlling the different types of traditional appliances.

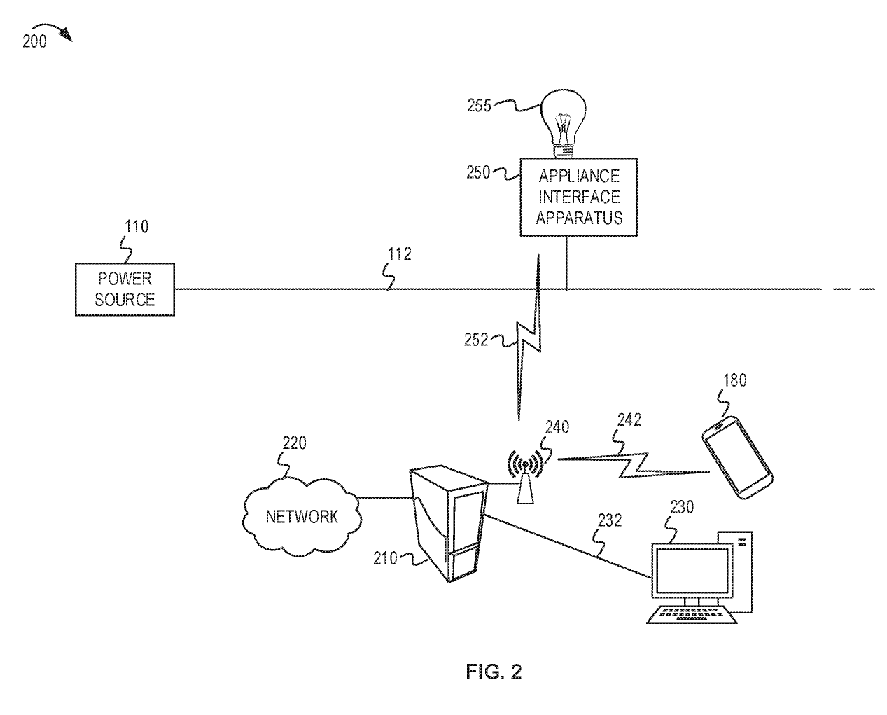

FIG. 2 shows a system diagram of an example appliance interface apparatus for networking a traditional appliance via a wireless local area network (WLAN). The system 200 includes the power source 110 and powerline medium 112. The powerline medium 112 provides power to a traditional appliance 255 and an appliance interface apparatus 250. The appliance interface apparatus 250 is configured to control the operation of the traditional appliance 255 by managing the power delivered from the powerline medium 112 to the traditional appliance 255. For example, the appliance interface apparatus 250 may send a signal to a control circuit (not shown) that controls power to the traditional appliance 255.

As found in many homes and businesses, a local network may be present in the system 200. For example, a router 210 (also known as a gateway) may provide network connectivity between client devices and a network 220. In the system 200, client devices 180, 230 are communicatively coupled to the router 210. A first client device 180 (shown as a mobile device) may have a WLAN communication link 242 to an access point 240. The access point 240 may be separate from the router 210 or may be integrated (or collocated) with the router 210. A second client device 230 (shown as a stationary computer) may have a physical communication link 232 (such as Ethernet) to the router 210. The appliance interface apparatus 250 also may have a WLAN communication link 252 via the access point 240 to the router 210.

In FIG. 2, the router 210 may operate as a smart appliance controller. For example, the router 210 may include a home automation platform for controlling a smart appliance or appliance interface apparatus. In some implementations, the smart appliance controller can reside within the router 210. In some other implementations, the smart appliance controller may be separate from the router and may be communicatively coupled to the router 210. In some implementations, the smart appliance controller may use a standard command protocol associated with smart home automation. Upon receiving a command from the smart appliance controller, the router 210 may forward the command via one or more network communication links to the appropriate smart appliance or appliance interface apparatus. For example, the router 210 may receive a command from the network 220 or either of the client devices 180, 230. The command may be associated with turning on or off the traditional appliance 255. The router 210 may forward the command to the appliance interface apparatus 250 via the WLAN communication link 252. In response to receiving the command, the appliance interface apparatus 250 may send a signal to a control circuit associated with the traditional appliance 255. The signal may cause the control circuit to enable (or disable) power from the powerline medium 112 to the traditional appliance 255. The appliance interface apparatus 250 may control operation of the traditional appliance 255 as if the traditional appliance 255 was a smart appliance responding to a command from the router 210, even though the traditional appliance 255 may itself not be capable of processing the command. In some implementations, the appliance interface apparatus 250 may translate the command from the standard command protocol used by the smart appliance controller into a signal that is appropriate for the control circuit. For example, the appliance interface apparatus 250 may establish a different communication link (not shown) with the control circuit that is different from the WLAN communication link 252

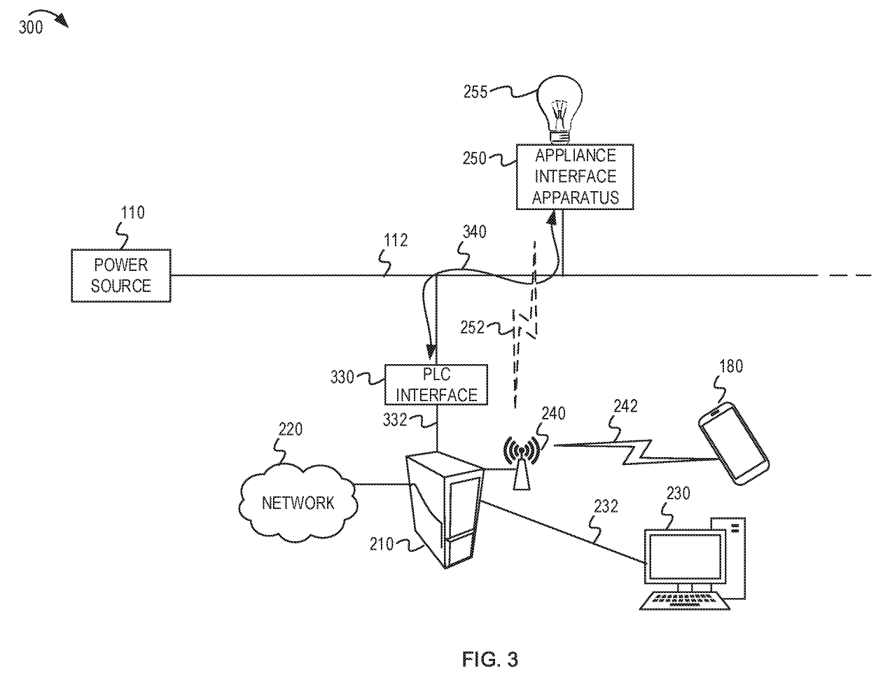

FIG. 3 shows a system diagram of an example appliance interface apparatus for networking a traditional appliance via a WLAN or a powerline communication (PLC) network. The system 300 includes the power source 110, powerline medium 112, appliance interface apparatus 250, traditional appliance 255, router 210, network 220, access point 240, client device 180, client devices 230, and communication links 242, 232, as described in FIG. 2. The system 300 shows that the appliance interface apparatus 250 may communicate with the router 210 using PLC over the powerline medium 112. A PLC interface 330 may couple the router 210 to the powerline medium 112. The PLC interface 330 may be communicatively coupled to the router 210 using an intermediate network medium 332 (such as Ethernet or Digital Subscriber Line (DSL)-based technologies). Alternatively, the PLC interface 330 may be integrated into the router 210.

A PLC network communication link 340 may be used by the appliance interface apparatus 250 to communicate via the powerline medium 112 (and PLC interface 330) to the router 210. The router 210 may include a home automation platform for forwarding commands to the appliance interface apparatus 250. Upon receiving a command from the network 220 or either of the client devices 180, 230, the router 210 may forward the command via the PLC interface 330 and PLC network communication link 340 to the appliance interface apparatus 250.

In some implementations, the appliance interface apparatus 250 may have more than one network interface. For example, the appliance interface apparatus 250 may be capable of using either or both the PLC network communication link 340 and the WLAN communication link 252, depending on network conditions. If the WLAN communication link 252 is not stable or has a weak signal, the appliance interface apparatus 250 may select the PLC network communication link 340 to communicate with the smart appliance controller. In some implementations, the appliance interface apparatus 250 may establish a different communication link (not shown) with the control circuit that is different from both the PLC network communication link 340 and the WLAN communication link 252.

In some implementations, a group of appliance interface apparatuses (not shown) may coordinate with each other to form a mesh network using one or more communication links. For example, some appliance interface apparatuses may support PLC and WLAN communication links, other appliance interface apparatuses may support PLC and wireless broadband connectivity, and so on. The group of appliance interface apparatus may coordinate with each other to form a mesh network with several types of communication links being supported. In some implementations, the appliance interface apparatuses may communicate using mobility management entity (MME) messaging to coordinate with each other to control different types of appliances through the mesh network.

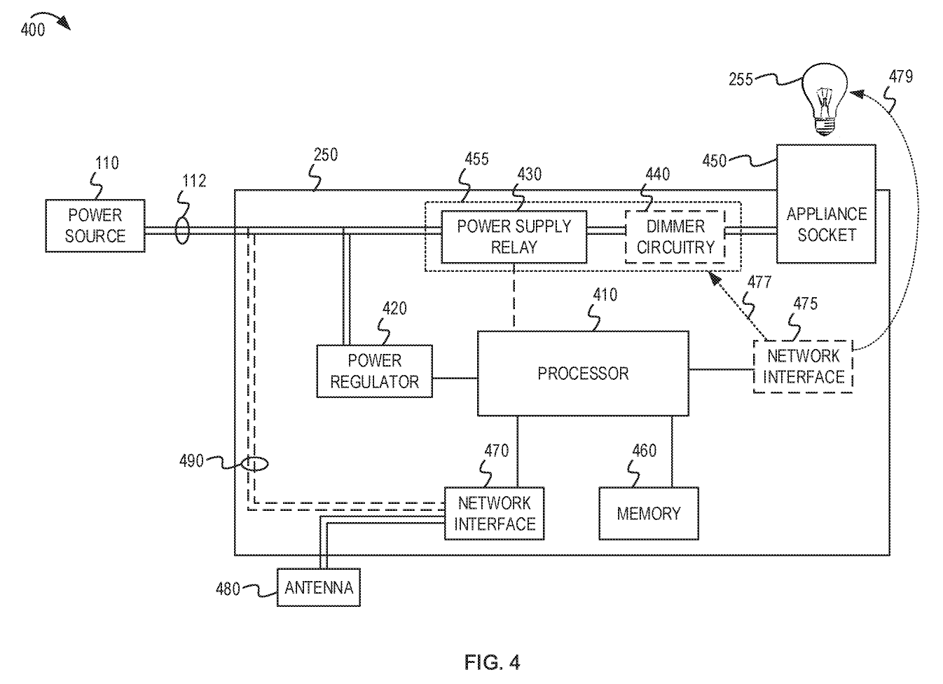

FIG. 4 shows a block diagram of an example appliance interface apparatus. The block diagram 400 depicts the power source 110, appliance interface apparatus 250, and traditional appliance 255. The appliance interface apparatus 250 includes an appliance socket 450 for coupling to the traditional appliance 255. The appliance interface apparatus 250 includes a processor 410, memory 460, and at least one network interface (such as network interface 470).

In FIG. 4, the powerline medium 112 carries power from the power source 110 to the appliance interface apparatus 250. The powerline medium 112 may be an alternating current (AC) powerline or a direct current (DC) powerline. As shown in FIG. 4, the powerline medium 112 may include two or more wires to carry the power from the power source 110. The powerline medium 112 is coupled to the appliance socket 450 for providing power to the traditional appliance 255. In some implementations, the power may be supplied via a control circuit 455 (such as a power supply relay 430 and, optionally, a dimmer circuitry 440). The power supply relay 430 may control whether the power from the power source 110 can reach the appliance socket 450. The control circuit may be integrated with the appliance interface apparatus 250 (as shown in FIG. 4) or may be separate. In some implementations, the control circuit 455 may be located in or near the appliance socket 450. When the control circuit 455 is located in the appliance interface apparatus 250, the power supply relay 430 may be enabled or disabled by the processor 410. In some implementations, an isolator circuit (not shown) can be used between the processor 410 and the power supply relay 430. Examples of an isolator circuit may include an optocoupler or any type of isolator circuitry to protect the processor 410 from a failure of the power supply relay 430, or vice versa. In some implementations, a solid-state relay (not shown) may be used in place of the power supply relay 430 and isolator circuit.

The processor 410 also may utilize power from the power source 110. In FIG. 4, a power regulator 420 is shown. For example, the power regulator 420 may convert AC power to DC power. The power regulator 420 also may regulate or change the amount of voltage supplied to the processor 410. In some other implementations (not shown), the processor 410 may be powered by a battery or wireless power source. Alternatively, the power source 110 may be a battery or wireless power receiver and may be integrated with the appliance interface apparatus 250. In some implementations, the same power source that provides power to the traditional appliance 255 (via the appliance socket 450) is also used to provide power to the processor 410.

The processor 410 is configured to receive commands from a smart appliance controller via a network. The network interface 470 provides connectivity between the appliance interface apparatus 250 and the network. In some implementations, the network interface 470 may be a WLAN interface which communicates via an antenna 480. For example, the WLAN interface may be configured to implement Wi-Fi-based technologies described in the IEEE 802.11 standards. In some other implementations, the network interface 470 may be a PLC interface which communicates via a PLC connection 490 to the powerline medium 112. For example, the PLC interface may be configured to implement PLC standard-approved technologies (such as IEEE P1905.1 or various HomePlug standards). In addition, or alteratively, the network interface 470 may implement other types of networking (such as Ethernet, token ring, optical networking, light-based communication, short-range radio frequency communication, and the like). For example, the network interface 470 may conform to specialized standards or protocols for a particular environment (such as a manufacturing-specific network, or a in-vehicle network). In some implementations, the appliance interface apparatus 250 may include more than one network interface and may be capable of sending or receiving commands via more than one network communication medium. For example, the appliance interface apparatus 250 may include a second network interface 475 that uses a different communication technology to communicate with the control circuit (shown at arrow 477). The second network interface 475 also may communicate (shown at arrow 479) with a control circuit of another component (not shown) in the traditional appliance 255.

In implementations that utilize the dimmer circuitry 440, the appliance interface apparatus also may include a dimmer voltage regulator or a pulse width modular (PWM) for managing the amount of voltage or timing used by the dimmer circuitry 440. For example, the PWM (not shown) may be used between the processor 410 and the dimmer circuitry 440 or may be included as part of the dimmer circuitry 440. Using the dimmer circuitry 440, the processor 410 can control operation of the traditional appliance 255. For example, the processor 410 can manage the dimming level (also called brightness) of light produced by a traditional light bulb. Furthermore, various types of dimmer circuitry 440 may be utilized for specialized light bulbs, such as for a light emitting diode (LED) light bulb or a compact fluorescent light (CFL) light bulb. In some implementations, the power supply relay 430 may be omitted or replaced by the dimmer circuitry 440.

In some implementations, the traditional appliance 255 is coupled to the appliance interface apparatus via an appliance socket that is specific to a type of traditional appliance. For example, if the traditional appliance is a light bulb, the appliance socket may be a lightbulb socket. The control circuit also may be specific to the type of traditional appliance. For example, if the traditional appliance is a light bulb, the control circuit (such as the power supply relay) may be physically integrated into the light bulb holder. Other types of appliance sockets and control circuits may be used with different types of traditional appliances. In some other implementations, the traditional appliance may be an appliance with a power cable and power plug (such as a coffee machine, lamp, television, toaster, or the like) designed to plug into a traditional power socket). For example, the appliance socket may be a power socket into which the power plug is inserted. The appliance interface apparatus may be installed as a new wall power socket or may be inserted into an existing wall power socket. The control circuit may be integrated with the traditional appliance. For example, the control circuit may be included on a control board in a washing machine, dishwasher, oven, refrigerator, or the like. The appliance interface apparatus may be used to retrofit an existing traditional appliance by interfacing with a communication port of the control board. The appliance interface apparatus may add network-based communication to the existing control board. Furthermore, the appliance interface apparatus may provide translation of a command in a command protocol used by a smart appliance controller to a signal that is appropriate for the control circuit in the traditional appliance. In some other implementations, the traditional appliance may be a wearable accessory and the appliance socket may correspond to a power supply line for providing power to the wearable accessory. A person having ordinary skill in the art may readily conceive of other examples of traditional appliances and related power sources which may be controlled by an appliance interface apparatus.

There may be other components in the appliance interface apparatus 250, not shown in FIG. 4. For example, a clock component may be utilized to supply clocking to the processor 410. Various types of memory may be utilized to store operating instructions for execution by the processor 410.

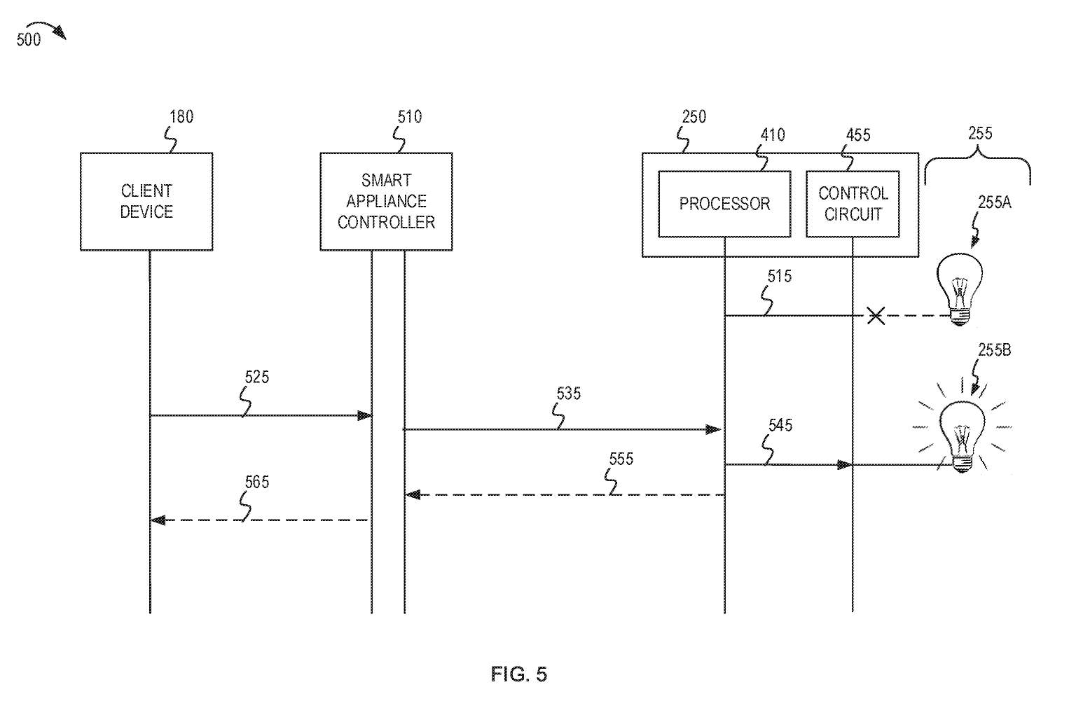

FIG. 5 shows a message flow diagram of an example traditional appliance using an appliance interface apparatus. The message flow diagram 500 shows a client device 180, smart appliance controller 510 (such as a controller integrated with the router 210) and an appliance interface apparatus 250. The appliance interface apparatus 250 includes a processor 410 and control circuit 455. In the example of FIG. 5, the control circuit 455 is located in the appliance interface apparatus 250. In some other implementations, the control circuit 455 may be located in the traditional appliance 255. In the example of FIG. 5, the control circuit 455 includes a power supply relay (not shown). The power supply relay is disabled in an initial state. In this initial state, the control circuit prevents power from going to the traditional appliance 255. Because the power supply relay is disabled, no power (shown at line 515). is supplied to the traditional appliance 255 and the traditional appliance 255 is turned off (shown at 255A).

At 525, the client device 180 sends a command associated with turning on the traditional appliance 255. The command is sent to the smart appliance controller 510. The smart appliance controller 510 forwards the command at 535 to the processor 410. In some implementations, the smart appliance controller 510 may be associated with multiple network interfaces and may receive or send commands over various network interfaces. The processor 410 receives the command and determines that the command includes an instruction to turn on the traditional appliance 255. In accordance with the command, the processor 410 may send a signal (at 545) to the control circuit 455 to cause the control circuit 455 to enable power. In the example of FIG. 5, the signal causes the control circuit 455 to enable power to the traditional appliance 255 and the traditional appliance 255 turns on (shown at 255B).

In some implementations, the signal (at 545) may use a different communication protocol than the command. For example, the appliance interface apparatus 250 may establish a first communication link to the smart appliance controller 510 using a first communication protocol. The command may be associated with a command protocol and may be formatted for communication using the first communication protocol. The appliance interface apparatus 250 may establish a second communication link to the traditional appliance 255 that uses a second communication protocol. For example, the second communication protocol may be associated with a serial or parallel cable interface to the control circuit. The processor 410 may translate the command into a signal (at 545) that is specific to the second communication link and the control circuit. In some implementations, the appliance interface apparatus 250 may download a hardware abstraction layer (or command translation instructions) that are specific to the type of appliance to which the appliance interface apparatus 250 is coupled. For example, the appliance interface apparatus 250 may download the hardware abstraction layer (or command translation instructions) on-demand during onboarding a new type of appliance. In some implementations, the appliance interface apparatus 250 may detect the type of appliance based on communication via the second communication link to the traditional appliance 255.

In some implementations, the processor 410 may send an acknowledgment message (shown at 555) to the smart appliance controller 510. The smart appliance controller 510 may forward the acknowledgment message (shown at 565) to the client device 180.

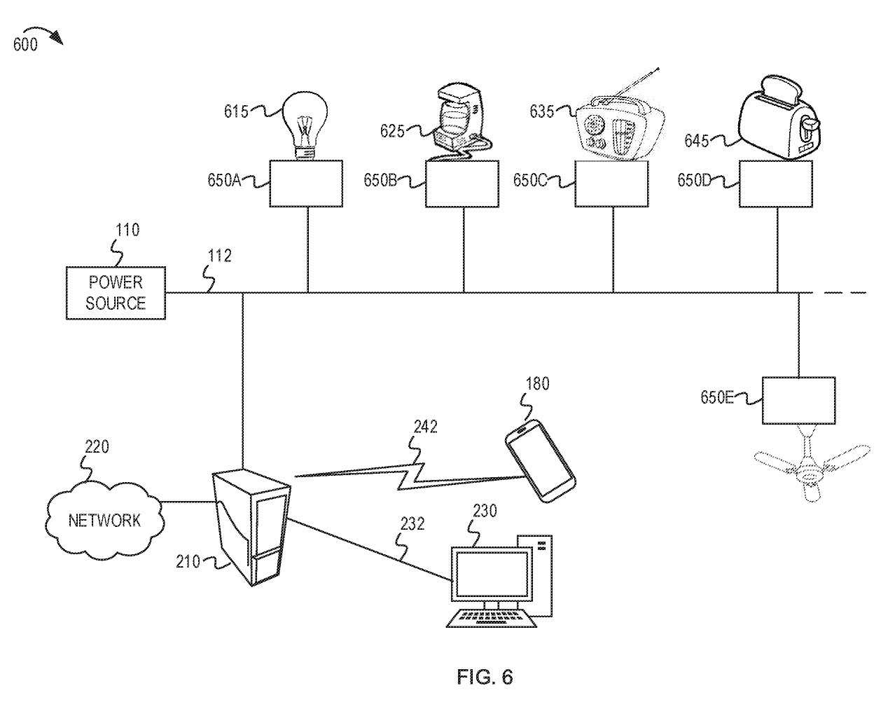

FIG. 6 shows a system diagram of example appliance interface apparatuses for controlling traditional appliances. The system 600 includes the power source 110, powerline medium 112, network 220, router 210, client device 180, client devices 230, and communication links 242, 232, as previously described. In the system 600, a plurality of appliance interface apparatuses may be deployed. For example, a first appliance interface apparatus 650A may control operation of a light bulb 615. A second appliance interface apparatus 650B may control operation of a coffee maker 625. A third appliance interface apparatus 650C may control operation of a radio 635. A fourth appliance interface apparatus 650D may control operation of a toaster 645. And, a fifth appliance interface apparatus 650E may control operation of a ceiling fan 655. The appliance interface apparatuses may have different types of appliance sockets. For example, the first appliance interface apparatus 650A may have a light bulb socket, while appliance interface apparatuses 650B, 650C, 650D may have power cable sockets for plugging in traditional appliances. The fifth appliance interface apparatus 650E may be built into a power unit that couples the traditional ceiling fan 655 to the powerline medium 112.

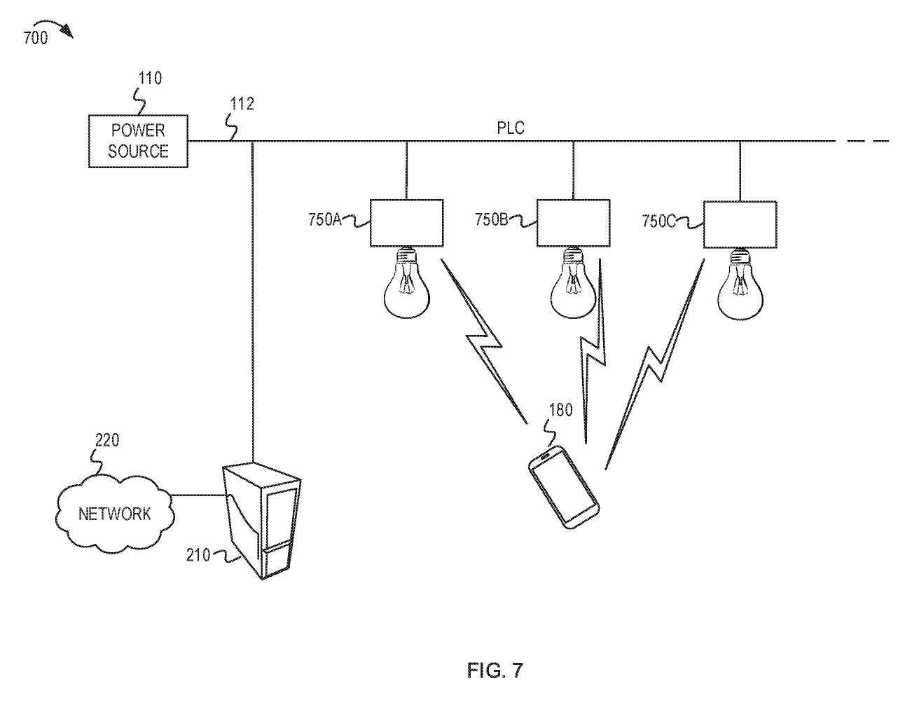

FIG. 7 shows a system diagram of example appliance interface apparatuses capable of bridging powerline networking and wireless networking while controlling traditional appliances. For example, an appliance interface apparatus may have both PLC and wireless network interfaces. The appliance interface apparatus may be capable of bridging PLC traffic to the wireless network interface and may be capable of acting as a wireless access point for a WLAN. In FIG. 7, the router 210 is coupled to a PLC network on the powerline medium 112. The appliance interface apparatuses 750A, 750B, 750C may be configured to connect a traditional appliance to the powerline medium 112. However, in addition to controlling an operation of the traditional appliance, the appliance interface apparatuses 750A, 750B, 750C also may provide wireless connectivity for the client device 180. For example, the client device 180 may send WLAN messages to the appliance interface apparatus 750A (or 750B or 750C) which are forwarded (also called bridged) via the PLC network to the router 210.

In some implementations, the appliance interface apparatuses 750A, 750B, 750C may be in an area that has poor wireless coverage. The smart appliance controller (not shown) may communicate via the router 210 and the powerline medium 112 to the appliance interface apparatuses 750A, 750B, 750C. The appliance interface apparatuses 750A, 750B, 750C may bridge the communications via the powerline medium 112 to WLAN messages and relay the commands to a WLAN interface in a smart appliance (not shown) near the appliance interface apparatuses 750A, 750B, 750C.

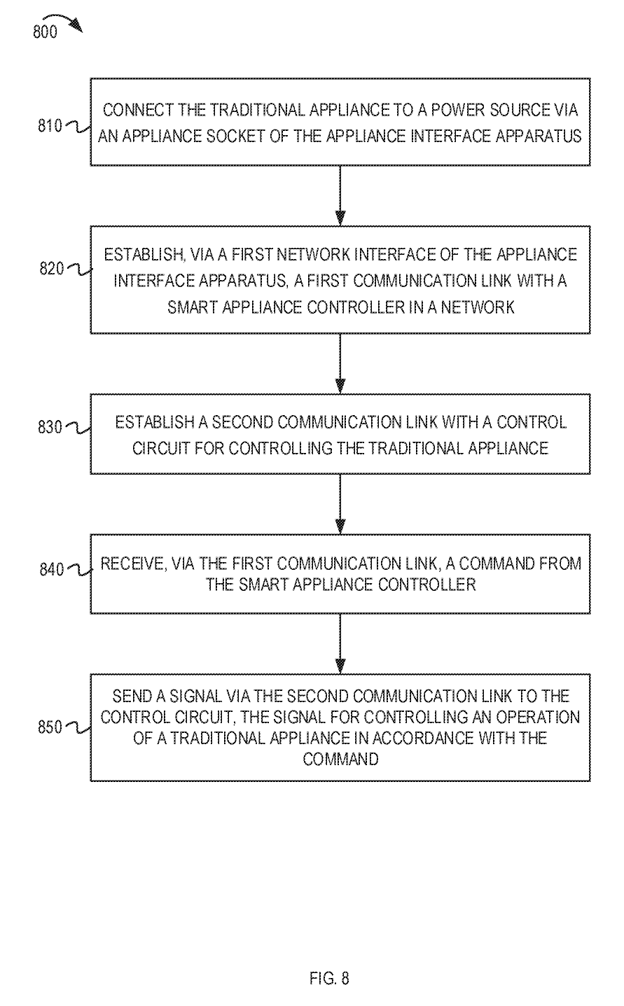

FIG. 8 shows a flowchart of an example appliance interface apparatus. The flowchart 800 begins at block 810. At block 810, the appliance interface apparatus may connect the traditional appliance to a power source via an appliance socket of the appliance interface apparatus. For example, the appliance socket may be a power cable, power plug, power socket, or the like, and may be specific to the type of traditional appliance. At block 820, the appliance interface apparatus may establish, via a first network interface of the appliance interface apparatus, a first communication link with a smart appliance controller in a network. For example, the first communication link may be a PLC network or WLAN communication link. At block 830, the appliance interface apparatus may establish a second communication link with a control circuit for controlling the traditional appliance. For example, the second communication link may be a wireless communication link (such as a short-range radio frequency link) or a wired link. In some implementations, the second communication link may use a serial or parallel communication cable to interface with a control board of the traditional appliance. At block 840, the appliance interface apparatus may receive a command from the smart appliance controller via the first communication link. At block 850, the appliance interface apparatus may send a signal via the second communication link to the control circuit. In some implementations, the appliance interface apparatus may translate the command from a first command protocol to the signal using a different communication protocol. The signal may control an operation of the traditional appliance in accordance with the command. For example, the signal may cause a power supply relay in the control circuit to enable or disable power supply to the traditional appliance.

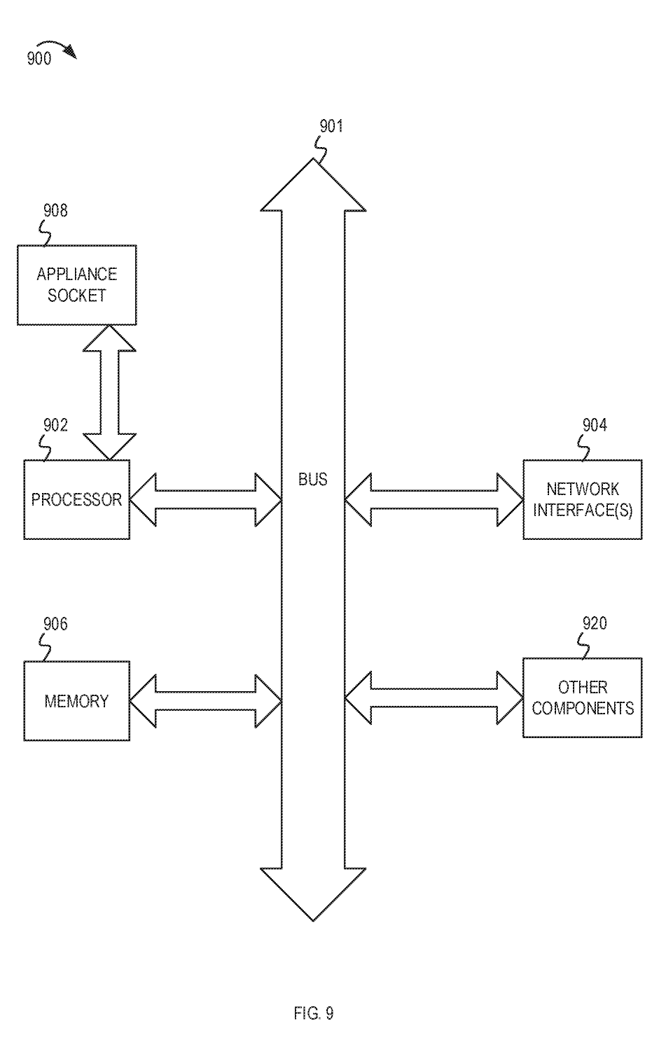

FIG. 9 shows a block diagram of an example electronic device 900 for implementing aspects of this disclosure. In some implementations, the electronic device 900 may be an appliance interface apparatus (such as appliance interface apparatus 250) or a smart appliance controller (such as router 210). The electronic device 900 includes an appliance socket 908 for coupling to a traditional appliance. The appliance socket 908 may be a light bulb holder, power plug, power cable socket, or the like. The electronic device 900 includes a processor 902 (possibly including multiple processors, multiple cores, multiple nodes, or implementing multi-threading, etc.). The electronic device 900 includes a memory 906. The memory 906 may be system memory or any one or more of the below described possible realizations of machine-readable media. The electronic device 900 also may include a bus 901 (such as PCI, ISA, PCI-Express, HyperTransport®, InfiniBand®, NuBus, AHB, AXI, etc.). The electronic device may include one or more network interfaces 904, which may be a wireless network interface (such as a WLAN interface, a Bluetooth® interface, a WiMAX interface, a ZigBee® interface, a Wireless USB interface, etc.) or a wired network interface (such as a powerline communication interface, an Ethernet interface, etc.). In some implementations, electronic device 900 may support multiple network interfaces 904—each of which may be configured to couple the electronic device 900 to a different communication network.

The memory 906 includes functionality to support various implementations described above. The memory 906 may include one or more functionalities that facilitate an appliance interface apparatus for networking a traditional appliance. For example, memory 906 can implement one or more aspects of appliance interface apparatus 250 as described above. The memory 906 can enable implementations described in FIGS. 1-8 above. The electronic device 900 also may include other components 920, such as a clock source, isolator circuitry, dimmer circuitry, or the like. In some implementations, the other components 920 may include a control circuit for controlling a traditional appliance.

Any one of these functionalities may be partially (or entirely) implemented in hardware, such as on the processor 902. For example, the functionality may be implemented with an application specific integrated circuit, in logic implemented in the processor 902, in a co-processor on a peripheral device or card, etc. Further, realizations may include fewer or additional components not illustrated in FIG. 9 (such as video cards, audio cards, additional network interfaces, peripheral devices, etc.). The processor 902, and the memory 906, may be coupled to the bus 901. Although illustrated as being coupled to the bus 901, the memory 906 may be directly coupled to the processor 902.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends on the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray™ disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine-readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method performed by an appliance interface apparatus for networking a traditional appliance, comprising:
connecting the traditional appliance to a power source via an appliance socket of the appliance interface apparatus;
establishing, via a first network interface of the appliance interface apparatus, a first communication link with a smart appliance controller in a network;
establishing a second communication link with a control circuit for controlling the traditional appliance;
receiving, via the first communication link, a command from the smart appliance controller; and
sending a signal via the second communication link to the control circuit, the signal for controlling an operation of the traditional appliance in accordance with the command.

2. The method of claim 1,
wherein the appliance interface apparatus includes a processor for receiving the command, and
wherein the processor is powered by the power source.

3. The method of claim 2, wherein sending the signal for controlling the operation of the traditional appliance includes:
translating the command from a first command protocol of the network to the signal for use on the second communication link.

4. The method of claim 1, wherein the control circuit is integrated into the traditional appliance.

5. The method of claim 1,
wherein the control circuit includes a power supply relay between a power source and the traditional appliance, and
wherein the signal causes the control circuit to enable or disable power to the traditional appliance via the power supply relay.

6. The method of claim 1, wherein sending the signal for controlling the operation of the traditional appliance includes sending the signal to the control circuit via an isolator circuit between the appliance interface adapter and a power supply relay of the control circuit.

7. The method of claim 1,
wherein the control circuit includes a dimmer circuitry between a power source and the traditional appliance, and
wherein the signal controls dimming of the traditional appliance via the dimmer circuitry.

8. The method of claim 1, wherein the traditional appliance is a light bulb, the appliance interface apparatus is a light bulb holder for holding the light bulb, the appliance socket is a lightbulb socket, and wherein the processor and the light bulb socket are physically integrated into the light bulb holder.

9. The method of claim 1, wherein the appliance interface apparatus includes more than one network interface.

10. The method of claim 9, wherein the appliance interface apparatus is capable of receiving the command from the smart appliance controller via more than one network communication medium.

11. The method of claim 9, wherein establishing the second communication link includes establishing the second communication link via a second network interface of the appliance interface apparatus.

12. The method of claim 11, wherein the first network interface is a powerline communication (PLC) interface and the second network interface is a wireless local area network (WLAN) interface.

13. The method of claim 1, wherein the appliance interface apparatus is capable of bridging communication between a PLC network and a WLAN.

14. The method of claim 1, wherein establishing the first communication link with the smart appliance controller includes:
forming a mesh network with one or more other appliance interface apparatuses, wherein the first communication link traverses the mesh network; and
communicating with the smart appliance controller via the mesh network.

15. An appliance interface apparatus for networking a traditional appliance, comprising:
a processor;
an appliance socket for connecting the traditional appliance to a power source;
at least a first network interface; and
memory having instructions stored therein which, when executed by the processor cause the appliance interface apparatus to:
establish, via the first communication link, a first communication link with a smart appliance controller in a network,
establish a second communication link with a control circuit for controlling the traditional appliance,
receive, via the first communication link, a command from the smart appliance controller, and
send a signal via the second communication link to the control circuit, the signal for controlling an operation of the traditional appliance in accordance with the command.

16. The appliance interface apparatus of claim 15, wherein the processor is powered by the power source.

17. The appliance interface apparatus of claim 15, wherein the instructions to send the signal for controlling the operation of the traditional appliance include instructions which, when executed by the processor, cause the appliance interface apparatus to:
translate the command from a first command protocol of the network to the signal for use on the second communication link.

18. The appliance interface apparatus of claim 15, wherein the instructions to receive the command include instructions which, when executed by the processor, cause the appliance interface apparatus to:
receive the command from the smart appliance controller via one of multiple network interfaces capable of receiving the command.

19. The appliance interface apparatus of claim 15, further comprising:
a second network interface for establishing the second communication link to the traditional appliance.

20. The appliance interface apparatus of claim 19, wherein the first network interface is a PLC interface and the second network interface is a WLAN interface.

21. A computer-readable medium having instructions stored therein which, when executed by a processor of an appliance interface apparatus for networking a traditional appliance, cause the appliance interface apparatus to:
connect the traditional appliance to a power source via an appliance socket of the appliance interface apparatus;
establish, via a first network interface of the appliance interface apparatus, a first communication link with a smart appliance controller in a network;
establish a second communication link with a control circuit for controlling the traditional appliance;
receive, via the first communication link, a command from the smart appliance controller; and
send a signal via the second communication link to the control circuit, the signal for controlling an operation of the traditional appliance in accordance with the command.

22. The computer-readable medium of claim 21, wherein the processor is powered by the power source.

23. The computer-readable medium of claim 21, wherein the instructions to send the signal for controlling the operation of the traditional appliance include instructions which, when executed by the processor, cause the appliance interface apparatus to:
translate the command from a first command protocol of the network to the signal for use on the second communication link.

24. The computer-readable medium of claim 21, wherein the instructions to receive the command include instructions which, when executed by the processor, cause the appliance interface apparatus to:
receive the command from the smart appliance controller via one of multiple network interfaces capable of receiving the command.

25. The computer-readable medium of claim 21, wherein the instructions to establish the second communication link include instructions which, when executed by the processor, cause the appliance interface apparatus to:
establish the second communication link via a second network interface of the appliance interface apparatus.

26. The computer-readable medium of claim 21, wherein the instructions, when executed by the processor, cause the appliance interface apparatus to:
bridge communication between a PLC network and a WLAN.

27. A system in an appliance interface apparatus, comprising:
means for connecting a traditional appliance to a power source via an appliance socket of the appliance interface apparatus;
means for establishing, via a first network interface of the appliance interface apparatus, a first communication link with a smart appliance controller in a network;
means for establishing a second communication link with a control circuit for controlling the traditional appliance;
means for receiving, via the first communication link, a command from the smart appliance controller; and
means for sending a signal via the second communication link to the control circuit, the signal for controlling an operation of the traditional appliance in accordance with the command.

28. The system of claim 27, further comprising:
means for translating the command from a first command protocol of the network to the signal for use on the second communication link.

29. The system of claim 27, wherein the means for establishing the second communication link include means for establishing the second communication link via a second network interface of the appliance interface apparatus.

30. The system of claim 27, further comprising:
means for bridging communication between a PLC network associated with the first communication link and a WLAN associated with the second communication link.
